(19) United States
(12) Patent Application Publication
(10) Pub. No.: US 2003/0042706 A1
(43) Pub. Date: Mar. 6, 2003

(54) Safety hitch device

(76) Inventor: Ralph L. Breese, Norman, OK (US)

Correspondence Address: Randal D. Homburg, P. O. Box 10470, Midwest City, OK, 73140-1470, US

(21) Appl. No.: 10/012,089

(22) Filed: Dec. 11, 2001

Related U.S. Application Data
(60) Provisional application No. 60/316,801, filed on Aug. 30, 2001.

(51) Int. Cl. B62D 53/06

(52) U.S. Cl. 280/432

(57) ABSTRACT

The invention is an attachment for a fifth wheel trailer hitch generally mounted within the bed of a vehicle to prevent damage to the vehicle in the event that the fifth wheel hitch fails due to faulty hook-up, the invention including a horizontal cross bar, two perpendicularly attached side bars with paired sets of bolt holes for mounting to the fifth wheel trailer hitch, a slide channel attached to the horizontal cross bar having an angle catch brace, and at least four bolts with lock nuts.

### CROSS REFERENCE TO RELATED APPLICATIONS

Provisional Patent Application, Serial No. 60/316,801 filed on Aug. 30, 2001.

### BACKGROUND OF THE INVENTION

1. Field of Invention

The invention is an attachment for a fifth wheel trailer hitch generally mounted within the bed of a vehicle to prevent damage to the vehicle in the event that the fifth wheel hitch fails due to faulty hook-up, the invention including a horizontal cross bar, two perpendicularly attached side bars with paired sets of bolt holes for mounting to the fifth wheel trailer hitch, a slide channel attached to the horizontal cross bar having an angle catch brace, and at least four bolts with lock nuts.

2. Description of Prior Art

The following United States patents were discovered and are disclosed within this application for utility patent. All relate to trailer hitch devices, specifically fifth wheel hitches or pivot plate hitches. However, none of them have any utility remotely relative to the current invention.

In U.S. Pat. No. 6,213,492 to Ceccarelli, III, an fifth wheel hitch attaching to an underlift T-bar mechanism is disclosed, wherein a fifth wheel hitch may be installed in a box hitch of a vehicle to tow a fifth wheel trailer. A lock mechanism is disclosed in U.S. Pat. Nos. 5,839,745 to Cattau and 3,823,960 to Boggs, which provide a secondary lock for retaining the fifth wheel pin within the locking plate of the fifth wheel hitch.

Some patents deal with safety coupling devices for fifth wheel hitches which provide a secondary attachment on the fifth wheel hitch in the event of kingpin failure, including U.S. Pat. Nos. 3,633,940 to Sinnard and 2,738,205 to Vaugoyeau. A safety plug for a fifth wheel hitch is disclosed in U.S. Pat. No. 3,823,961 to Korodi, while an anti-jack-knifing control bar is the subject of U.S. Pat. No. 4,700,966 to Hawkins.

### SUMMARY OF THE INVENTION

The primary objective of the invention is to provide a device attaching to a fifth wheel trailer hitch to protect the vehicle from damage in the event of a failed engagement of the fifth wheel hitch and the kingpin of the trailer at hookup or during detachment caused by the kingpin coming loose from the hitch and dropping onto the bed rails of the vehicle bed.

### DESCRIPTION OF THE DRAWINGS

The following drawings are submitted with this utility patent application.

FIG. 1 is a perspective view of the invention.

FIG. 2 is a top view of the invention.

FIG. 3 is a side cross section of the slide plate in relation to the kingpin.

FIG. 4 is a front view of a fifth wheel hitch to which the invention is applied.

FIG. 5 is a side view of the invention installed in a fifth wheel hitch in relation to the front of a fifth wheel trailer.

### DESCRIPTION OF THE PREFERRED EMBODIMENT

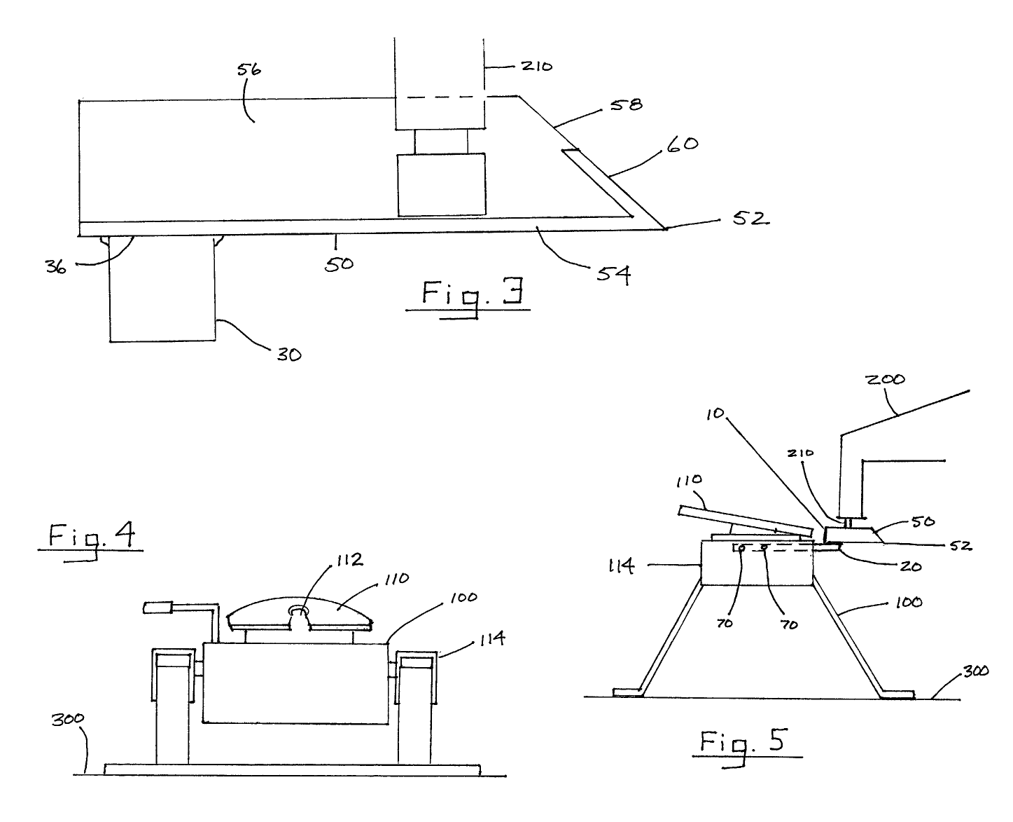

The invention is a safety hitch device 10 attaching to a fifth wheel trailer hitch 100, shown in FIG. 4 of the drawings, having a receiver plate 110 with a kingpin slot 112, mounted to the bed 300 of a pickup, receiving a kingpin 210 from a fifth wheel trailer 200, the device 10 essentially comprising a U-shaped member 20 having a bight portion 30, two parallel legs 40, a channel segment 50 traversely mounted to the bight portion 30, and an angled rigid safety bar 60 affixed within the channel segment 50 to engage the kingpin 210 depending from the fifth wheel trailer 200.

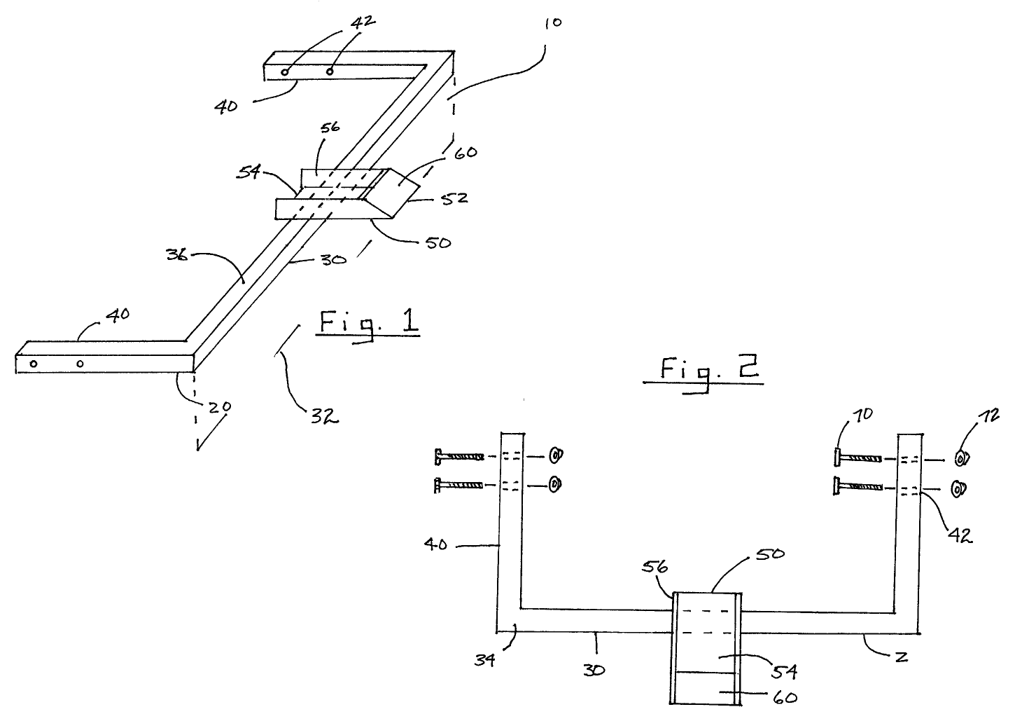

The U-shaped member 20, as shown in FIGS. 1 and 2 of the drawings, further includes the bight portion 30 having a length 32 and two ends 34, and the two legs 40, one leg perpendicularly attached to each end 34 of the bight portion 30, the two legs 40 being parallel. The length 32 of the bight portion 30 is such that the two attached parallel legs 40 will cooperatively span a width of a mounting frame 114 of the fifth wheel trailer hitch 100, the mounting frame 114 having supplied pairs of holes, securing the parallel legs 40 to the mounting frame 114 by at least four bolts 70 and four lock nuts 72, such parallel legs 40 each having at least one pair of holes 42.

The channel segment 50, as shown in FIG. 3 of the drawings, is upwardly open and traversely secured to an upper side 36 of the bight portion 30, the channel segment 50 having a front edge 52 and a base segment 54 from which two perpendicularly ascending walls 56 attach, the front edge 52 of the channel segment 50 relating outward from the bight portion 30 in an opposing planar direction as the two parallel legs 40. Affixed between the ascending walls 56 of the channel segment 50 is the angled rigid safety bar 60 which suitably engages the kingpin 210 depending from the fifth wheel trailer 200. Most preferably, the ascending walls 56 have a vertical taper 58 arising from the front edge 52 of the channel segment 50.

Each pair of holes 42 in the legs 40 are presented to be aligned with holes located in the mounting frame 114 and retained by the bolts 70 and lock nuts 72, whereafter the channel segment 50 is aligned with the kingpin slot 112 in the receiver plate 110, as shown in FIG. 5 of the drawings, directing the kingpin 210 from the fifth wheel trailer 200 from the channel segment 50 into the receiver plate 110, the kingpin 210 riding over the safety bar 60 as the kingpin 210 is directed towards the kingpin slot 112. However, on removal of the kingpin 210 from the kingpin slot 112, the kingpin 210 would ride upon the base segment 54 and the kingpin 210 would catch itself on the safety bar 60, unless the kingpin 210 is raised to a level above the safety bar 60, as shown in FIG. 3 of the drawings. Thus, in the event of an unintentional separation of the kingpin 210 from the kingpin slot 112 of the receiver plate 110 in fifth wheel trailer hitch 100, wherein gravity would normally cause the fifth wheel trailer 200 to fall upon a tailgate or bed rails of the pickup bed 300 causing damage, the kingpin 210, upon separation from the kingpin slot 112 of the receiver plate 110, will fall into the channel segment 50 and become snagged by the safety bar 60, avoiding damage to the pickup.

While the invention has been particularly shown and described with reference to a preferred embodiment thereof, it will be understood by those skilled in the art that changes in form and detail may be made therein without departing from the spirit and scope of the invention.

What is claimed is:

1. A safety hitch device attaching to a fifth wheel trailer hitch mounted to a bed of a pickup, such fifth wheel trailer hitch having a receiver plate with a kingpin slot accepting a kingpin from a front of a fifth wheel trailer, the device essentially comprising:
a. a U-shaped member having a bight portion and two parallel legs;
b. a channel segment traversely mounted to the bight portion; and
c. an angled rigid safety bar affixed within the channel segment to engage the kingpin of the fifth wheel trailer depending from the front of the fifth wheel trailer when the kingpin is within the channel segment.

2. The device, as disclosed in claim 1, further comprising:
a. the bight portion having a length and two ends, and the two legs, one leg perpendicularly attached to each end of the bight portion, the two legs being parallel;
b. the length of the bight portion such that the two attached parallel legs will cooperatively span a width of a mounting frame of the fifth wheel trailer hitch, the mounting frame having supplied pairs of holes, securing the parallel legs to the mounting frame by at least four bolts and four lock nuts, such parallel legs having at least one pair of holes;
c. the channel segment is upwardly open and traversely secured to an upper side of the bight portion, the channel segment having a front edge and abase segment from which two perpendicularly ascending walls attach, the front edge of the channel segment relating outward from the bight portion in an opposing planar direction as the two parallel legs, the ascending walls have a vertical taper arising from the front edge of the channel segment; and
d. the rigid angled safety bar affixed between the ascending walls of the channel segment engaging the kingpin of the trailer depending from the front of the trailer.

3. The device as disclosed in claim 2, wherein:
a. the channel segment, after attachment to the fifth wheel trailer hitch, is aligned with the kingpin slot in the receiver plate, directing the kingpin from the trailer from the channel segment into the receiver slot, the kingpin riding over the safety bar as the kingpin is directed towards the receiver slot;
b. the kingpin, when directed away from the receiver slot, would ride upon the base segment, such kingpin catching itself on the safety bar, unless the kingpin is raised to a level above the safety bar; thus
c. in the event of an unintentional separation of the kingpin from the kingpin slot of the receiver plate in fifth wheel hitch, wherein gravity would normally cause the front of the trailer to fall upon a tailgate or bed rails of the pickup bed causing damage, the kingpin, upon separation from the kingpin slot of the receiver hitch, would fall into the channel segment and catch on the safety bar, avoiding damage to the pickup.
